(19) United States
(12) Patent Application Publication
(10) Pub. No.: US 2025/0309777 A1
(43) Pub. Date: Oct. 2, 2025

(54) CONTROL SYSTEMS

(71) Applicant: VIRIDIS SOLUTIONS LTD., Doddinghurst, Brentwood Essex (GB)

(72) Inventor: Peter Joseph Green, Doddinghurst, Brentwood Essex (GB)

(21) Appl. No.: 18/862,539

(22) PCT Filed: Mar. 23, 2023
(86) PCT No.: PCT/EP2023/057549

§ 371 Date: Nov. 3, 2024

(30) Foreign Application Priority Data
May 3, 2022 (GB) 2206448.9

(51) Int. Cl. H02M 5/293

(52) U.S. Cl. CPC H02M 5/293

(57) ABSTRACT

In some examples, a control system for regulating a three-phase power supply comprises, for each one of multiple sources of alternating current (AC), the AC sources configured to supply respective input AC signals each with defined phases, a control device configured to receive an input AC signal from an AC source and a neutral signal, each control device comprising a gated regulating system configured to provide an output AC signal according to a predetermined threshold value of current, a phase monitor to receive the output AC signals from each of the control devices, and an output device configured to output a three-phase power supply using the output AC signals, wherein the output device is configured to receive a control signal from the phase monitor, the control signal calculated on the basis of at least one of the input AC signals and the output AC signals.

### TECHNICAL FIELD

The present disclosure relates, in general, to three-phase power supplies. Aspects of the disclosure relate to regulating a three-phase power supply.

### BACKGROUND

Power factor (PF) is a parameter used for measuring power consumption efficiency of electrical equipment and can be defined as the ratio between the useful (true) power to the total (apparent) power consumed by an item of electrical equipment or a complete electrical installation. It therefore forms a measure of how efficiently electrical power is converted into useful work output. A load with a power factor of 1.0 results in the most efficient loading of the supply

To improve the power consumption efficiency, power factor correction (PFC) can be applied to an Alternating Current (AC) input signal before the AC input signal is supplied to the electrical equipment. PFC is used to restore the power factor to as close to unity as is economically viable.

PFC can be achieved by the addition of capacitors in parallel with the connected electrical equipment, such as a motor or lighting circuit and can be applied at the equipment, distribution board or at the origin of the installation. Static power factor correction can be applied at each individual motor by connecting correction capacitors to the motor starter for example. A disadvantage can occur when the load on the motor changes which can result in under or over correction.

### SUMMARY

An objective of the present disclosure is to provide a control system to monitor, and reduce the electrical consumption of a electrical equipment, such as an AC motor for example.

The foregoing and other objectives are achieved by the features of the independent claims.

Further implementation forms are apparent from the dependent claims, the description and the Figures.

A first aspect of the present disclosure provides a control system for regulating a three-phase power supply, the control system comprising, for each one of multiple sources of alternating current (AC), the AC sources configured to supply respective input AC signals each with defined phases, a control device configured to receive an input AC signal from an AC source and a neutral signal, each control device comprising a gated regulating system configured to provide an output AC signal according to a predetermined threshold value of current, a phase monitor to receive the output AC signals from each of the control devices, and an output device configured to output a three-phase power supply using the output AC signals, wherein the output device is configured to receive a control signal from the phase monitor, the control signal calculated on the basis of at least one of the input AC signals and the output AC signals.

In an implementation of the first aspect, each gated regulating system can comprise a triode for AC (Triac) or silicon controlled rectifier (SCR). The phase monitor can be configured to receive an input AC signal. The phase monitor can be configured to generate the control signal by comparing a phase of the input AC signal with a phase of at least one of the output AC signals. The output device can be configured to receive the neutral signal. The phase monitor can be configured to independently monitor the output of each of the control devices. A transformer can be provided and configured to supply a stepped-down power supply to at least one of the control devices and the phase monitor. Each control device can comprise a logic control configured to control an output of a corresponding gated regulating system. A logic control can be configured to generate an output signal for the gated regulating system configured to regulate a mode of operation of the gated regulating system between active, inactive and energy saving modes of operation.

A second aspect of the present disclosure provides a method for regulating a three-phase power supply, the method comprising using an input AC signal comprising one phase component of a three-phase power supply, generating an first input signal for a logic control from a zero-cross detector, generating a second input signal for the logic control from a current sensing circuit, and generating a third input signal for the logic control from a voltage sensing circuit, and generating, using the logic control, on the basis of the first, second and third input signals, a control signal for a gated regulating system, the control signal configured to regulate the output of the gated regulating system.

The method can further comprise using the output of the gated regulating system, controlling a power supply derived from the three-phase power supply. The method can further comprise generating a control signal, using the logic control, comprising a 0v signal with 5v pulses provided at predetermined intervals. The method can further comprising determining a zero point crossing of the input AC signal, and generating a 5v pulse to coincide with each detected zero point crossing. The method can further comprising determining a duration for a 5v pulse using a pulse width timer. The method can further comprise selectively activating an output power signal, whereby to provide an energy saving mode for a load configured to receive the three-phase power supply.

A third aspect of the present disclosure provides a control device for use in a control system, such as a control system provided according to the first aspect. The control device can receive an input AC signal from an AC source, and a neutral signal, and can comprise a gated regulating system configured to provide an output AC signal according to a predetermined threshold value of current. In an example, the control device can comprise a logic control configured to use the input AC signal to generate an first input signal for a logic control from a zero-cross detector, generate a second input signal for the logic control from a current sensing circuit, generate a third input signal for the logic control from a voltage sensing circuit, and generate, on the basis of the first, second and third input signals, a control signal for the gated regulating system, the control signal configured to regulate the output of the gated regulating system. Multiple such control devices can be provided. For example, each phase component a multi-phase supply, such as a three-phase power supply, can be provided with a control device.

These and other aspects of the invention will be apparent from the embodiment(s) described below.

### BRIEF DESCRIPTION OF THE DRAWINGS

In order that the present invention may be more readily understood, embodiments of the invention will now be described, by way of example, with reference to the accompanying drawings, in which:

FIG. 1 is a schematic representation of a control system according to an example;

FIG. 2 is a schematic representation of a control system according to an example;

FIG. 3 is a table for implementing an output of a logic control according to an example;

FIG. 4 is a schematic representation of a control system according to an example;

FIG. 5 is a schematic representation of a phase monitor according to an example;

FIG. 6 is a schematic representation of a control system according to an example;

FIG. 7 is a schematic representation of a control system according to an example;

FIG. 8 is a schematic representation of a part of a control system according to an example; and

FIG. 9 is a schematic representation of a part of a control system according to an example.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed.

On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

Three-phase electric motors are a type of AC motor that is a specific example of a polyphase motor that can be either an induction motor (also called an asynchronous motor) or a synchronous motor. It is generally understood that three-phase electric motors are the most efficient and do not require any intervention to save money whilst the motor is in use. Accordingly, even though a PFC device, comprising banks of capacitors for example, may be installed at the incoming three-phase supply (e.g., by fuse boards), it is commonly understood that such a device will not improve the consumption of three-phase electrical motors in any meaningful way.

According to an example, there is provided a control system for regulating a three-phase power supply. The control system is configured to monitor the phase of each component of a three-phase power supply individually, and is disposed between electrical equipment (to be powered) and the three-phase power supply. Since most electronic components are rated at 300v, not 415v that three-phase operates at, it was generally not considered possible to use an electronic device to monitor across three phases.

In an example, each phase of a three-phase power supply comprises its own control device that can monitor load, voltage, and current used by, e.g., a motor that is to be powered by the three-phase power supply, and that can be used to adjust savings as these parameters change. Each of the control devices are interlinked, and a phase monitor is provided and configured such that, should one control device fail, it registers and shuts of the output to protect the electrical equipment being supplied.

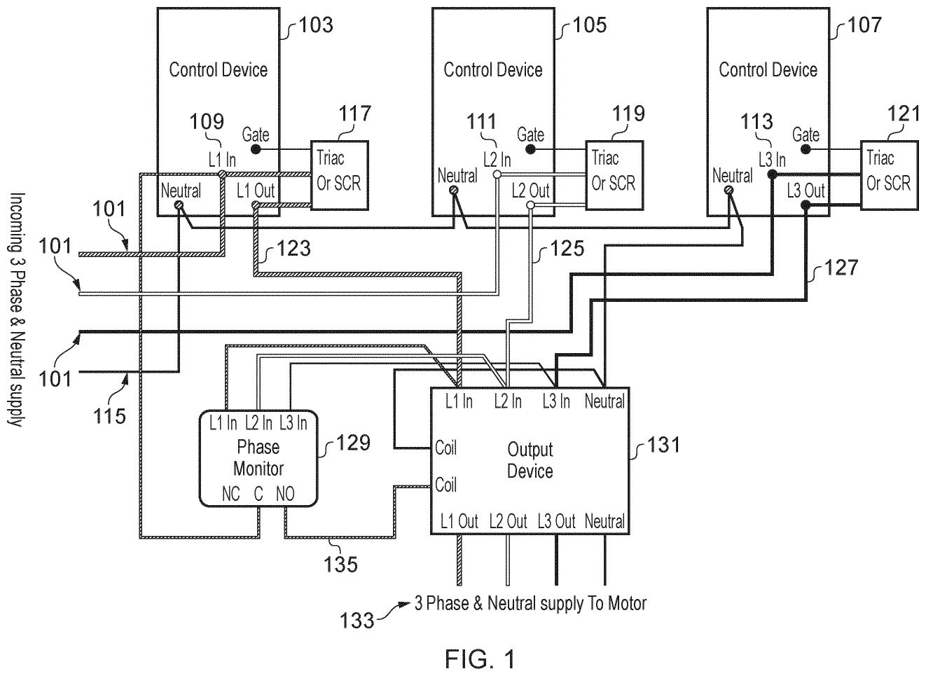

FIG. 1 is a schematic representation of a control system according to an example. The control system of FIG. 1 is configured to regulate a three-phase power supply. Accordingly, for each one of multiple sources of alternating current (AC) 101 each of which being configured to supply respective input AC signals each with defined phases, there is provided a control device 103, 105, 107. Each of the control devices is configured to receive an input AC signal 109, 111, 113 from an AC source 101, and a neutral signal 115. Accordingly, for each of the signals 101 from a three-phase supply, there is a corresponding control device.

In an example, each control device comprises a gated regulating system 117, 119, 121. Each one of the gated regulating systems is configured to provide an output AC signal 123, 125, 127 according to a predetermined threshold value of current.

A phase monitor 129 is configured to receive the output AC signals 123, 125, 127 from each of the control devices 103, 105, 107. An output device 131 is configured to output a three-phase power supply 133 using the output AC signals 123, 125, 127. In an example, the output device 131 is configured to receive a control signal 135 from the phase monitor 129. The control signal 135 can be calculated on the basis of at least one of the input AC signals 109, 111, 113 and the output AC signals 123, 125, 127.

According to an example, the output AC signals 123, 125, 127, forming a three-phase power supply, can be used to power an, e.g., AC induction motor, which can comprise an AC motor for, e.g., a refrigerator, air-conditioning system or other appliance. The output AC signals 123, 125, 127 are provided through the gated regulating system 117, 119, 121, which can comprise a triode for AC (Triac) or one or more silicon controlled rectifiers (SCR).

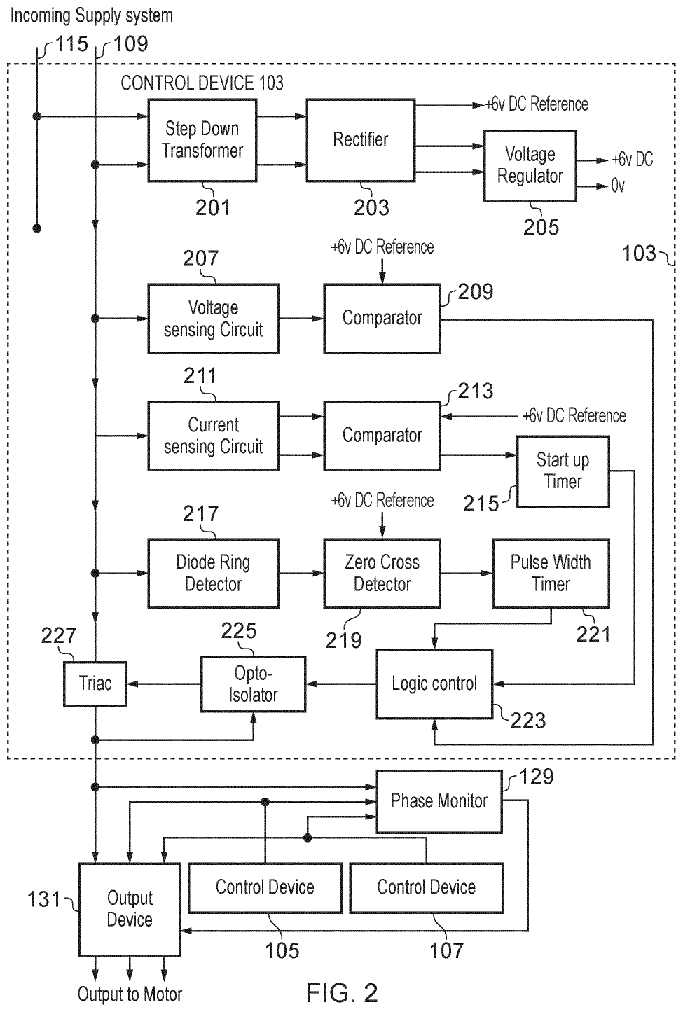

FIG. 2 is a schematic representation of a control system according to an example. In the example of FIG. 2, components of a control device 103 are depicted. Control device 103 is shown in more detail in FIG. 2. Control devices 105 and 107 comprise the same internal components, and the description provided with reference to control device 103 is equally applicable to either of control devices 105 or 107.

Supply 109 is received at control device 103 as an input AC signal from a three-phase power supply to be regulated. A step-down transformer 201, rectifier 203 and voltage regulator 205 can be provided to generate a 6V DC reference voltage and 5v DC voltage from the input AC signal 109. The 5V DC voltage can be used to, e.g., power one or more components of the control device 103. The 6V DC voltage can be input to a comparator 209, which also receives an input from a voltage sensing circuit 207, which is configured to receive the input AC signal 109. Comparator 209 generates an output signal that is input to a logic control 223. A current sensing circuit 221 is configured to receive the input AC signal 109, and generates outputs signals for a comparator 213, which also receives the 6V DC signal. The output of the comparator 213 is provided to a start up timer 215, which generates an output signal that is provided to the logic control 223. A diode ring detector 217 is configured to receive the input AC signal 109 and generate an output that is provided to a zero cross detector 219. The zero cross detector provides an output signal to a pulse width timer 221, which generates an output that is provided to the logic control 223. A triac 227 is configured to receive the input AC signal 109, as well an input signal provided from an opto-isolator 225, which itself receives a signal from the logic control 223 and a signal comprising the output of the triac 227. The output of the triac 227 is provided to the output device 131.

When the control system is powered on, and an input AC signal 109 is received, the step down transformer 201, rectifier 203 and voltage regulator 205 become active. A power on time delay (e.g., 10 s) can be activated, using start up timer 215 for example. Accordingly, a electrical load, such as a motor, can be powered on at full power for 10 seconds. A zero cross is detected using zero cross detector 219, and the voltage sensing circuit 207 checks that the incoming supply 109 has not fallen below a predetermined threshold value. The current sensing circuit 211 can determine whether the motor is drawing to much current. After the time delay ends, the output of the zero cross detector 219 is provided to the pulse width timer 221, and outputs from the voltage sensing circuit 207, current sensing circuit 211, and the pulse width timer 221 are provided to logic circuit 223. According to an example, an output and control of triac 227 is dependent on an output of the logic circuit 223, which can be calculated using a truth table for example, as will be described in more detail below.

An output of the triac 227 can adjust constantly according to current load of the motor. Should the voltage fall below 20% of incoming supply 109, control device 103 can be triggered to turn off the motor. Should the motor require 20% more current when in an energy saving mode, the control device 103 can cause the motor to be switched to full power for, e.g., 10 seconds or until a current draw is back within normal limits.

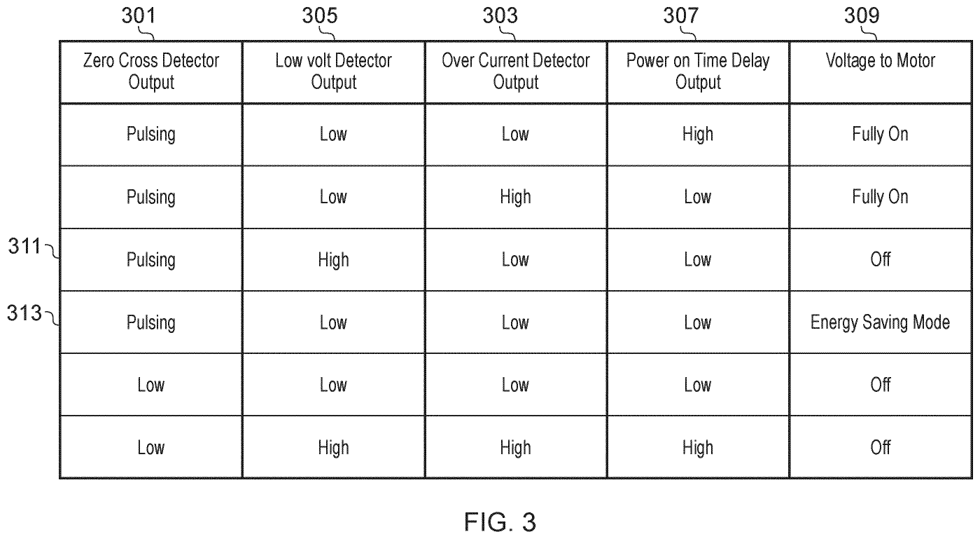

FIG. 3 is a table for implementing an output of a logic control according to an example. With reference to FIG. 2, logic control 223 receives an input signal 301 from the zero-cross detector 219 via the pulse width timer 221, an input signal 303 from the current sensing circuit 221 via the comparator 213 and start-up timer 215, and an input signal 305 from the voltage sensing circuit 207 via comparator 209. Accordingly, the output of the logic circuit can be used to regulate the output of the triac 227, and thus the power supply from the control system, using various inputs that vary over the course of supply of electrical equipment with a three-phase power supply. That is, depending on the output state of each section (Zero Cross, Low volt, over current and power on delay) the Triac 227 can be configured as follows:

Zero Cross=Detection of a zero cross of the voltage and amperage which produces a pulse of +5v on both the positive and negative portion of an AC power supply when a load is attached to the device.

Low volt=if the incoming Voltage to a device comprising electrical equipment is above a pre-determined range (e.g., not less than 20% of the incoming voltage, therefore 230v would be a range of 184v to 230v) the output of the circuit can be 0v. If it is below this range, the output can rise to +5v.

Over current=if the outgoing amperage rises above a pre-determined range (e.g., not more than 20%) the output of the circuit can be 0v. If it is above this range (e.g., if a 10 A load is running, and it draws 12 A) the output can rise to +5v. This resets the Power on timer and holds the load at full power for a pre-determined time (the Start-up time).

Power on timer=when the device first starts, a power on timer output is +5V and the opto-isolator 225 is held constantly ON. After a pre-determined time (e.g., 10 s), the output can go to 0V, and the opto-isolator 225 can be controlled by the logic control 223 (e.g., via a transistor, not shown).

For example, referring to the logic truth table of FIG. 3, row 311, Zero cross=dual+5v pulse, Low volt=+5v (i.e., high), Over current=0v (i.e., low), power on timer=0v (i.e., low). The output of the logic control 223 is configured, in such a scenario, to produce a 0v output representing an off state, thus turning off the opto-isolator 225 and Triac 227.

Referring to row 313, Zero Cross=dual+5v pulse, Low volt=0v, Over current=0v, and Power on timer=0v. These inputs to the logic control 223 cause it to output a 0v signal with 5v pulses at a precise time the zero cross is detected. The width of these pulses can be determined by the pulse width timer 221 for example. This state will reduce the power used by the attached load, providing an Energy Saving Mode.

The zero cross point will move along a waveform depending on the current and voltage being used on the load. Because the Zero Cross detector circuit 219 monitors this point in real time, the optimum point at which to implement or enter an energy saving mode is always correct. (i.e., point at which the triac 227 is turned off and back on again (around 2 ms for 230v) as described above). For example, if a small current increase occurs, the zero cross can move on the waveform by around 0.1 mS, therefore the device would move where the voltage is turned off and back on again forward by the same 0.1 ms increment.

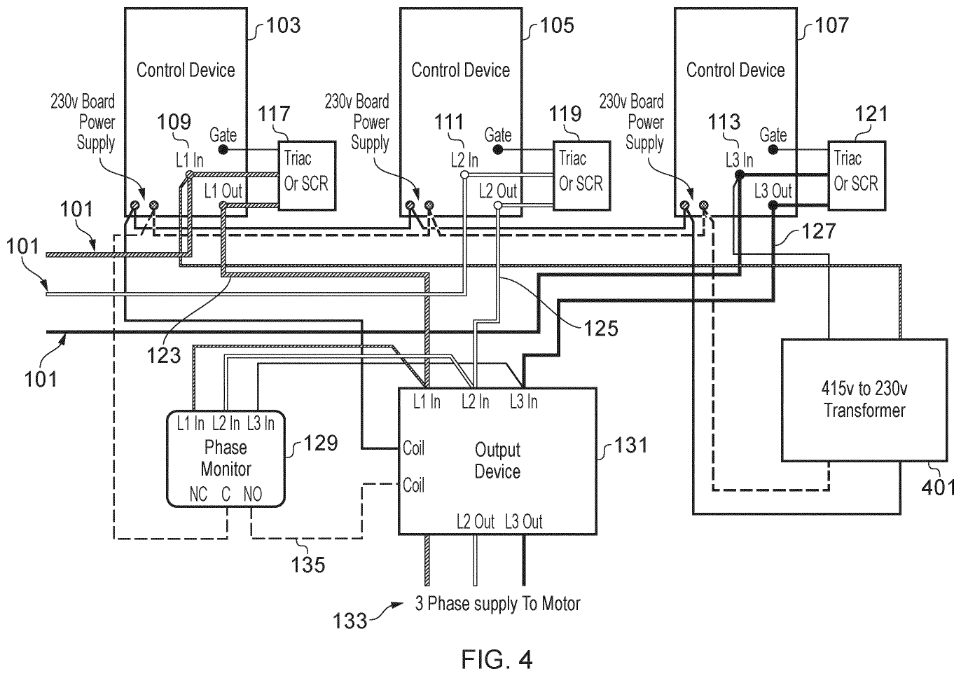

FIG. 4 is a schematic representation of a control system according to an example. The control system of FIG. 4 is the same as that described with reference to FIG. 1, with the exception that a transformer 401 is provided in order to step-down an input voltage to provide a 230V output to, e.g., power the control devices.

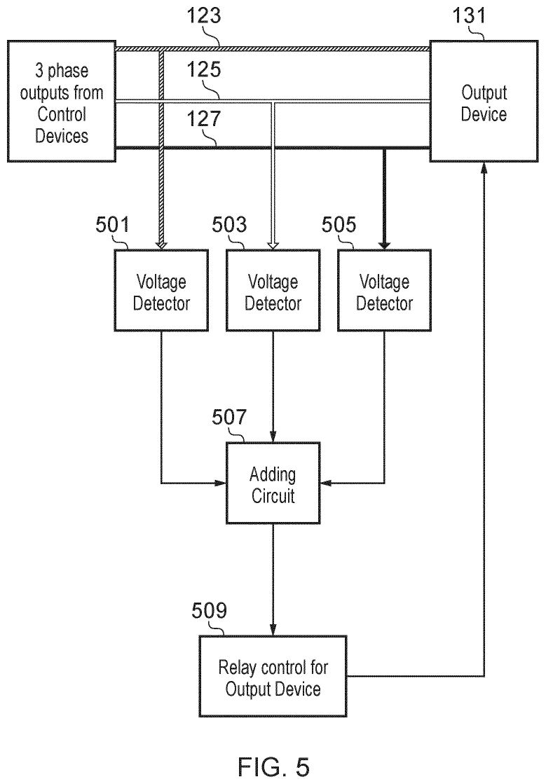

FIG. 5 is a schematic representation of a phase monitor according to an example. In the example of FIG. 5, the outputs 123, 125, 127 of the control devices 103, 105, 107 respectively, are provided as corresponding inputs to voltage detectors 501, 503, 505 to detect the voltage level of each of the outputs 123, 125, 127 of the control devices 103, 105, 107. An adding circuit 507 is used to add the voltage levels, as determined using the voltage detectors 501, 503, 505, together, and the resultant value is used as input to a relay control 509 for the output device 131. Accordingly, should an output 123, 125, 127 from any one of control devices 103, 105, 107 fall below a predetermined minimum value, the relay control 509 can be triggered to provide a control signal 135 for the output device 131, whereby to cause the control system to switch off, thereby preventing any damage to any connected electrical equipment.

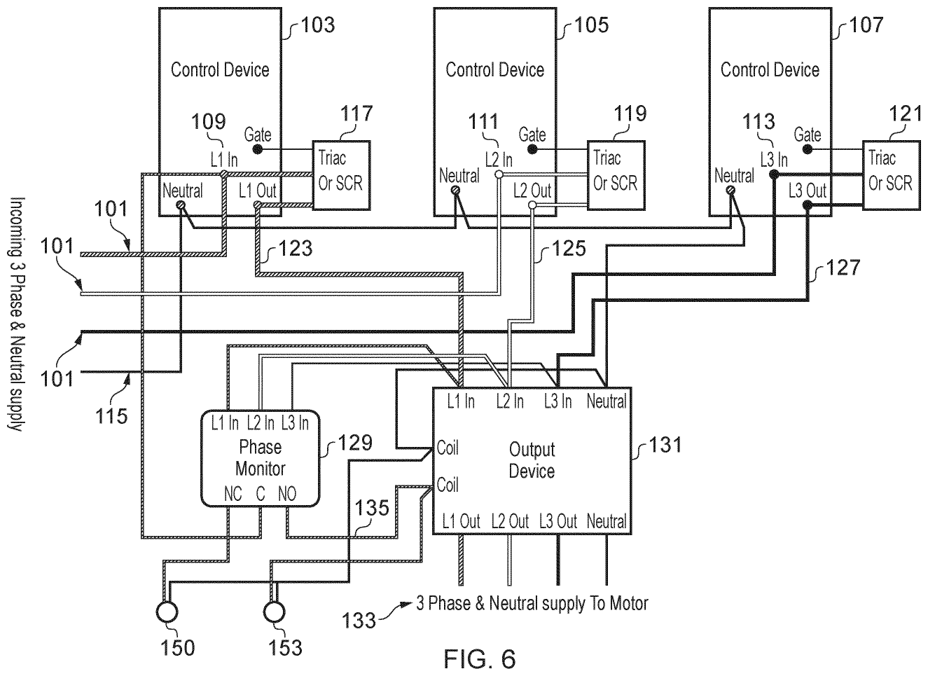

FIG. 6 is a schematic representation of a control system according to an example. The control system of FIG. 6 is the same as that of FIG. 1 except that display indicators 150, 153 are provided. The display indicators 150, 153 can be, e.g., LEDs, and are configured to show the state of the phase monitor 129. For example, an LED 150 (which can be red) can indicate that the phase monitor 129 is malfunctioning, whilst an LED 153 (which can be green) can indicate normal operation of phase monitor 129.

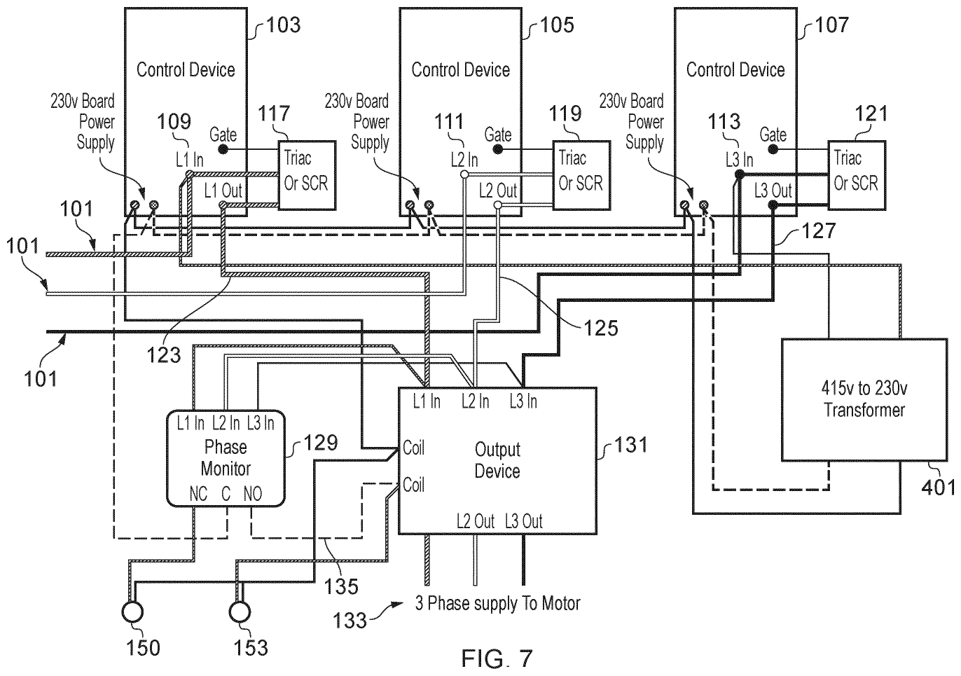

FIG. 7 is a schematic representation of a control system according to an example. The control system of FIG. 7 is the same as that of FIG. 4 except that display indicators 150, 153 are provided. These have the same function as those described with reference to FIG. 6.

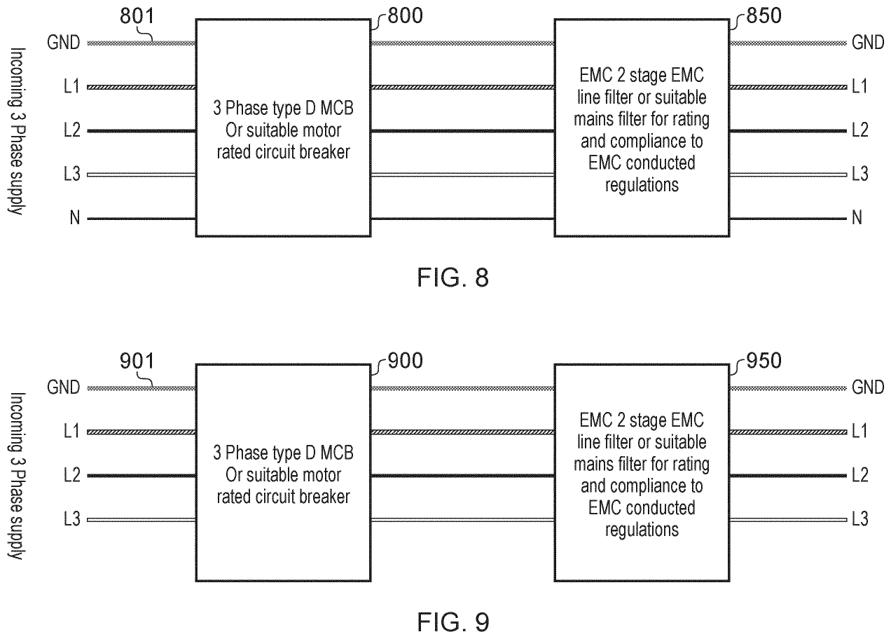

FIG. 8 is a schematic representation of a part of a control system according to an example. In the example of FIG. 8, two components are provided on the input lines of the control system depicted in FIG. 1 or 6. That is, components 800 and 850 are provided for each one of the multiple sources of alternating current (AC) 101 and the neutral signal 115. A ground signal 801 is depicted, but is not shown in FIG. 1 or 6 for the sake of clarity. Component 800 comprises a three phase type D miniature circuit breaker (MCB), or a suitable motor rated circuit breaker. Component 850 comprises an electromagnet countermeasure (EMC) two stage EMC line filter or suitable mains filter to limit electromagnetic disturbance for rating and compliance to EMC conducted regulations.

FIG. 9 is a schematic representation of a part of a control system according to an example. In the example of FIG. 9, two components are provided on the input lines of the control system depicted in FIG. 4 or 7. That is, components 900 and 950 are provided for each one of the multiple sources of alternating current (AC) 101. A ground signal 901 is depicted, but is not shown in FIG. 4 or 7 for the sake of clarity. Component 900 comprises a three phase type D miniature circuit breaker (MCB), or a suitable motor rated circuit breaker. Component 950 comprises an electromagnet countermeasure (EMC) two stage EMC line filter or suitable mains filter to limit electromagnetic disturbance for rating and compliance to EMC conducted regulations.

According to an example, a control device can be provided for use in a control system, such as a control system described above with reference to FIGS. 1 to 5 for example. The control device can receive an input AC signal from an AC source, and a neutral signal, and can comprise a gated regulating system configured to provide an output AC signal according to a predetermined threshold value of current. In an example, the control device can comprise a logic control configured to use the input AC signal to generate an first input signal for a logic control from a zero-cross detector, generate a second input signal for the logic control from a current sensing circuit, generate a third input signal for the logic control from a voltage sensing circuit, and generate, on the basis of the first, second and third input signals, a control signal for the gated regulating system, the control signal configured to regulate the output of the gated regulating system. Multiple such control devices can be provided. For example, each phase component a multi-phase supply, such as a three-phase power supply, can be provided with a control device.

1. A control system for regulating a three-phase power supply, the control system comprising:
for each one of multiple sources of alternating current (AC), the AC sources configured to supply respective input AC signals each with defined phases,
a control device configured to receive an input AC signal from an AC source and a neutral signal, each control device comprising a gated regulating system configured to provide an output AC signal according to a predetermined threshold value of current;
a phase monitor to receive the output AC signals from each of the control devices; and
an output device configured to output a three-phase power supply using the output AC signals;
wherein the output device is configured to receive a control signal from the phase monitor, the control signal calculated on the basis of at least one of the input AC signals and the output AC signals.

2. The control system as claimed in claim 1, wherein each gated regulating system comprises a triode for AC (Triac) or silicon controlled rectifier (SCR).

3. The control system as claimed in claim 1, wherein the phase monitor is further configured to receive the input AC signal.

4. The control system as claimed in claim 3, wherein the phase monitor is configured to generate the control signal by comparing a phase of the input AC signal with a phase of at least one of the output AC signals.

5. The control system as claimed in claim 1, wherein the output device is further configured to receive the neutral signal.

6. The control system as claimed in claim 1, wherein the phase monitor is further configured to independently monitor the output of each of the control devices.

7. The control system as claimed in claim 1, further comprising a transformer configured to supply a stepped-down power supply to at least one of the control devices and the phase monitor.

8. The control system as claimed in claim 2, wherein each control device comprises a logic control configured to control an output of a corresponding gated regulating system.

9. The control system as claimed in claim 8, wherein a logic control is further configured to generate an output signal for the gated regulating system configured to regulate a mode of operation of the gated regulating system between active, inactive and energy saving modes of operation.

10. A method for regulating a three-phase power supply, the method comprising:
using an input AC signal comprising one phase component of a three-phase power supply, generating a first input signal for a logic control from a zero-cross detector, generating a second input signal for the logic control from a current sensing circuit, and generating a third input signal for the logic control from a voltage sensing circuit; and
generating, using the logic control, on the basis of the first, second and third input signals, a control signal for a gated regulating system, the control signal configured to regulate the output of the gated regulating system.

11. The method as claimed in claim 10, further comprising:
using the output of the gated regulating system, controlling a power supply derived from the three-phase power supply.

12. The method as claimed in claim 10, further comprising:
Generating, using the logic control, a control signal comprising a 0v signal with 5v pulses provided at predetermined intervals.

13. The method as claimed in claim 12, further comprising:
determining a zero point crossing of the input AC signal; and
generating a 5v pulse to coincide with each detected zero point crossing.

14. The method as claimed in claim 12, further comprising:
determining a duration for a 5v pulse using a pulse width timer.

15. The method as claimed in claim 10, further comprising:
selectively activating an output power signal, whereby to provide an energy saving mode for a load configured to receive the three-phase power supply.

16. A control device for use in a control system for regulating a three-phase power supply, the control device configured to receive an input AC signal from an AC source, and a neutral signal, wherein the control device comprises a gated regulating system configured to provide an output AC signal according to a predetermined threshold value of current, the control device comprising:
a logic control configured to use the input AC signal to:
generate a first input signal for a logic control from a zero-cross detector;
generate a second input signal for the logic control from a current sensing circuit
generate a third input signal for the logic control from a voltage sensing circuit; and
generate, on the basis of the first, second and third input signals, a control signal for the gated regulating system, the control signal configured to regulate the output of the gated regulating system.
